(19) United States
(12) Patent Application Publication
(10) Pub. No.: US 2004/0061504 A1
(43) Pub. Date: Apr. 1, 2004

(54) Vacuum circuit-breaker and a method for controlling the same

(76) Inventors: Bernd-Heiko Krafft, Berlin (DE); Karl Mascher, Berlin (DE)

Correspondence Address: MORRISON & FOERSTER LLP, 1650 TYSONS BOULEVARD, SUITE 300, MCLEAN, VA, 22102, US

(21) Appl. No.: 10/466,638

(22) PCT Filed: Nov. 29, 2001
(86) PCT No.: PCT/DE01/04541

(30) Foreign Application Priority Data
Jan. 19, 2001 (DE) 101 04 392.9

(51) Int. Cl. H01H 33/66

(52) U.S. Cl. 324/424

(57) ABSTRACT

The aim of the invention is to improve the interrupting capacity of a vacuum switch, to achieve this, the contact parts (4, 5) that can be displaced in relation to each other are separated at a variable speed. Separation takes place in such a way that during a predetermined time period a predetermined distance between the contacts is not exceeded. To prevent said predetermined distance from being exceeded, a braking element is allocated to the vacuum circuit breaker.

The present invention relates to a control system for controlling a vacuum switch whose contact system has at least two contact pieces (4, 5) which can move relative to one another and are separated from one another at a changing speed during a disconnection process, and between which an arc which is to be quenched burns during the disconnection process.

A control system such as this is known, for example, from Patent Specification DE 38 15 805 C1. The disconnection movement of a contact arrangement of a vacuum switch is controlled by means of eccentric drive member. The configuration of the mechanical lever chain is in this case chosen such that an opening separation of 1 mm between the contact pieces is achieved after a very short acceleration phase (1.3 ms) of a movable contact piece. This document furthermore describes the fact that it has been found to be particularly advantageous for a contact piece separation speed of 2 m/s to be reached after 0.8 ms. This technical solution is based on the idea of quenching an arc, which is struck after contact separation, as quickly as possible, in order to prevent the contact material of the contact pieces from melting. It is assumed that a vacuum switch can also achieve high disconnection power levels by reaching a contact separation speed which is as high as possible, as quickly as possible.

However, it is technically impossible to increase the contact separation speed indefinitely. Furthermore, when disconnecting high currents, it is necessary to ensure that these currents can be quenched advantageously only within a specific contact piece separation range. Outside this quenching range, it is technically highly complex to influence an arc such that it is finally quenched as quickly as possible.

The present invention is thus based on the object of designing a control device for a vacuum switch such that arcs which occur during a disconnection process can be quenched more reliably, with a technically acceptable level of complexity.

In the case of a control system of the type mentioned initially, the object is achieved according to the invention in that the control system results in a given distance between the contact pieces being exceeded only after a time period which is predetermined by the control system has elapsed.

In order to assist the quenching of the disconnection arc, it is necessary to influence the arc such that it burns as diffusely as possible. The behavior of the arc is in this case substantially influenced by the shape of the contact pieces, and by the distance between the contact pieces. If the given separation between the contact pieces is not exceeded within a predetermined time period, then the quenching of the arc has been found to be an object which can be achieved with a technically acceptable level of complexity. The predetermined time period is the maximum interval which is necessary for the respective switch configuration before the arc is finally quenched. If the given distance were to be exceeded during the predetermined time period, then considerably more extensive technical designs would be necessary. In this case, the electromagnetic forces acting on the arc, and which are caused by the current to be interrupted and are supported by the rotation and hence the cooling and quenching of the arc, would not be available to a sufficient extent.

In addition to the control system, a method is also provided for switching a vacuum switch whose contact system has at least two contact pieces which can move relative to one another and are separated from one another at a changing speed during a disconnection process, and between which an arc which is to be quenched burns during the disconnection process.

This method provides that until the arc is finally quenched, the average speed of the contact separation in a first phase is greater than the average speed of the contact separation in a second phase, which immediately follows the first phase.

In the past, it has been assumed that quenching of an arc in a vacuum switch should always be carried out at as high a contact separation speed as possible. It was assumed that the achievement of greater contact separation speeds is directly linked to the vacuum switch having a higher switching capacity.

In order to cope with the disconnection currents which occur in the high-voltage range as well, it has been found to be advantageous, until the arc is finally quenched, to choose the average speed of contact separation in a first phase to be greater than the average speed of the contact separation in a second phase which immediately follows the first phase. It is thus possible to utilize the electromagnetic forces of the current to be disconnected over a longer time period, in order to allow the arc to rotate and to have as diffuse a configuration as possible. Furthermore, such a speed profile makes it possible to use a relatively low-power drive for moving the contact pieces.

A further method for switching a vacuum switch whose contact system has at least two contact pieces which can move relative to one another and are separated from one another at a changing speed during a disconnection process, and between which an arc which is to be quenched burns during the disconnection process provides that, in a first time period but before the arc is finally quenched, the distance between the contact pieces is increased from a first contact separation which can be predetermined, at least to a second contact separation, which can be predetermined, and at most to a third contact separation, which can be predetermined, and in a second time period which follows the first time period in time and before the arc is finally quenched, the distance between the contact pieces remains between the second contact separation and the third contact separation.

If the separation of the contact pieces is controlled such that the contact separation change in a first time period and in a second time period takes place as described above, this ensures, even in the case of high voltages, that the arc is reliably quenched in a short time. The contact separation may vary in a relatively wide range in the first time period. The restriction of the variation range of the contact separation in the second time period ensures, with a high degree of reliability, that restriking of the arc is impossible even when the peak value of a returning voltage occurs. The first contact separation is the distance at which the arc can be quenched for the first time, as a function of the respective switch configuration. The quenching of the disconnection arc can be started even in the first time period. With favorable preconditions, the arc can also be finally quenched even in the first time period. Such favorable preconditions are essentially governed by the time of the start of the disconnection movement with respect to the phase angle at that time of the current to be disconnected.

Furthermore, it is advantageously possible to provide for the first time period to start as soon as the first contact separation is reached.

If the first time period starts at the time at which the first contact separation is reached, then this ensures that the time required for the entire disconnection process is minimized.

Furthermore, it is advantageously possible to provide for the end of the second time period to differ from the time at which of the contact pieces reach the disconnected limit positions.

If the time at which the disconnection limit positions of the contact pieces are reached is separated from the end of the second time period, then it is possible to optimize the disconnection movement for arc quenching. Once the arc has been quenched, the contact pieces can be moved to their disconnection limit positions at any desired speed. After the end of the second time period, there is no longer any risk of restriking of the arc.

It is furthermore advantageously possible to provide for the speed of contact separation to be controlled as a function of the current to be disconnected.

Control of the speed of contact separation as a function of the current to be disconnected is particularly effective, since, if a very large current is being disconnected, for example a short-circuit current, the contact separation sequence is subject to different requirements than, for example, when disconnecting a rated current.

It is furthermore possible to provide for a vacuum switch for carrying out one of the methods described above and for operation by means of the described control system to be configured such that a movable contact piece has an associated electromagnetic braking device.

Electromagnetic braking devices are able to brake movements virtually without any wear occurring. They are thus highly suitable for braking a movable contact piece of a vacuum switch. It is thus possible to influence the movement sequence of contact separation such that this can be combined with the described control system, and the intended movement forms, contact separations and time periods are complied with.

It is also advantageously possible to provide for a movable contact piece to have an associated electro-mechanical braking device.

Electromechanical braking devices can be purchased extremely cheaply and are sufficiently suitable for decelerating movement processes.

It is furthermore advantageously possible to provide for the capability for parts which are connected to a movable contact piece to be movable in a magneto-rheological liquid.

When subjected to a magnetic field, magneto-rheological liquids react by changing their viscosity extremely quickly. As such, liquids such as these are highly suitable for braking assemblies moving in them. The braking effect of braking devices which make use of this effect can be controlled very well over a wide range.

The described methods and apparatuses are particularly suitable for use in vacuum switches, which are used at voltage levels above 50 kV for interrupting short-circuit currents of 30 kA or more.

The invention will be described in more detail in the following text with reference to an exemplary embodiment, and will be illustrated in the drawing, in which:

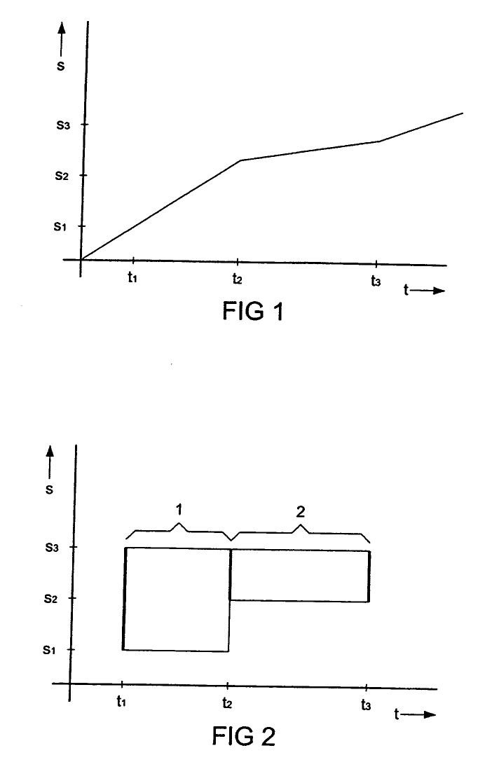

FIG. 1 shows a distance-time diagram, with a profile of the change in the distance between the contact pieces during disconnection,

FIG. 2 shows a distance-time diagram, with a first time period and a second time period,

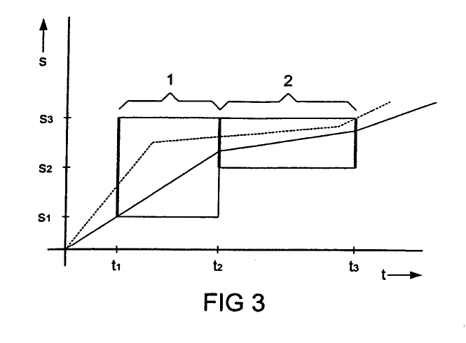

FIG. 3 shows a plurality of possible distance-time characteristics with a first and a second time period,

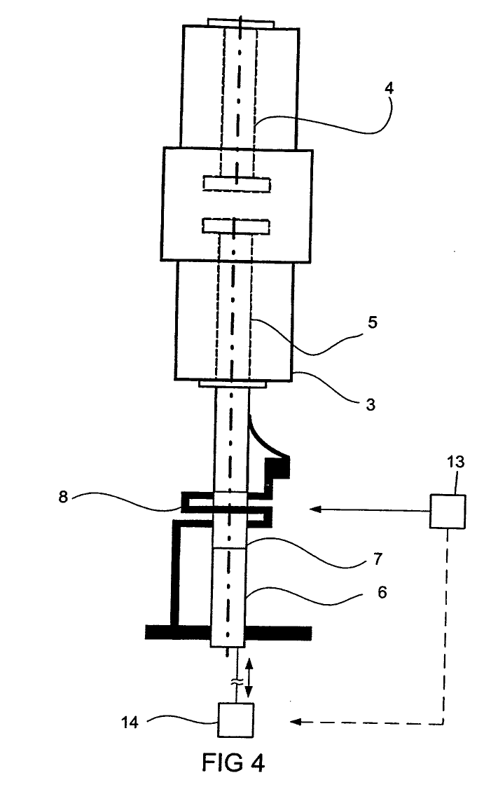

FIG. 4 shows a vacuum interrupter of a vacuum switch with an electromagnetic braking device,

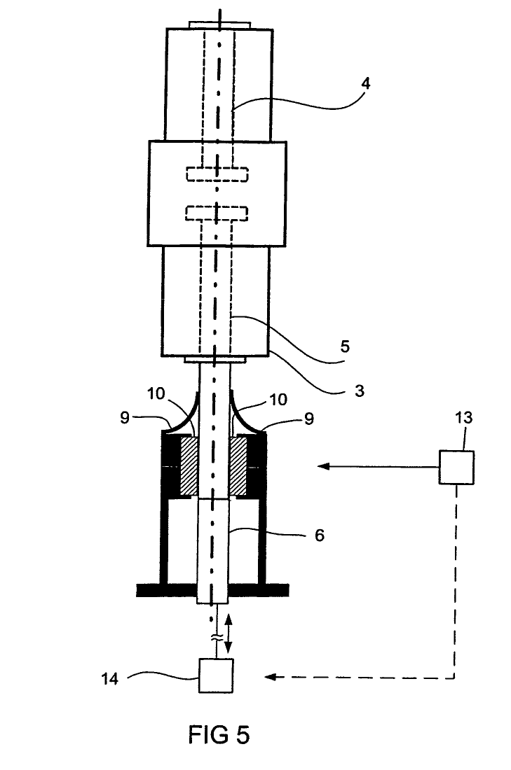

FIG. 5 shows a vacuum interrupter of a vacuum switch with an electromagnetical braking device, and

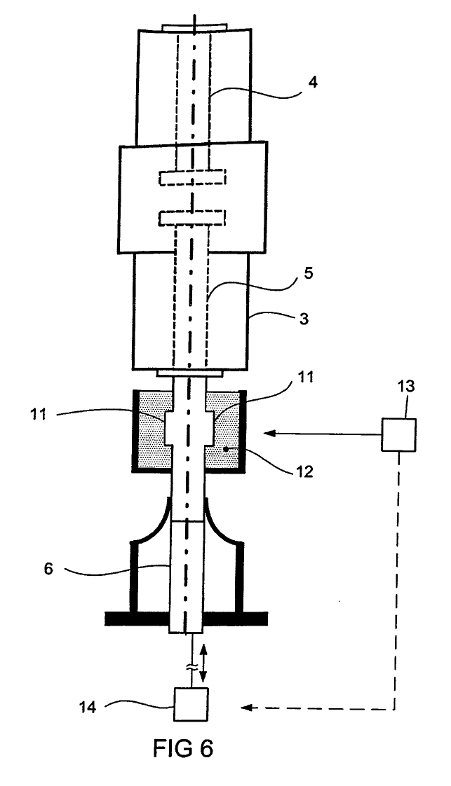

FIG. 6 shows a vacuum interrupter of a vacuum switch with a liquid braking device.

FIGS. 1, 2 and 3 show distance-time diagrams for disconnection movements of a vacuum switch. The time t which passes during a disconnection process is plotted on the abscissa of the coordinate system, with the conductive separation between the contact pieces taking place at the coordinate origin. The distance s between the contact pieces is plotted on the ordinate. FIG. 1 shows one possible profile of a disconnection movement according to the invention. The disconnection movement starts at the time t=0 when the contact pieces are conductively separated. Initially, the distance between the two contact pieces increases continuously. A first contact separation s1 between the contact pieces is reached at a first time t1. Until a time t2, the contact pieces are separated at a constant speed. A second contact separation s2 is reached at the time t2. After reaching the second contact separation s2, the relative contact separation movement takes place at a reduced speed until a third time t3. The contact separation between the contact pieces does not exceed a given third separation s3 at any time between the first time t1 and the third time t3. The third time t3 is in this case chosen such that an arc which is burning between the two contact pieces is reliably finally quenched at this time. After reaching the third time t3, it is possible for the third separation s3 to be exceeded. The contact pieces are normally moved to their limit positions after the third time t3.

A value of 8-9 ms after conductive separation of the contact pieces has been found to be a typical value for the time t2. There should be a time interval of 12 ms between the first time t1 and third time t3. The third separation s3 is approximately 3 to 5 times as great as the first separation s1. The second separation s2 is governed by the voltage level at which the vacuum switch is intended to be used.

FIG. 2 shows the following times described in FIG. 1: the first time t1, the second time t2, the third time t3, and the associated distances between the contact pieces, the first contact separation s1, the second contact separation s2 and the third contact separation s3. A first time period 1 is formed between the first time t1 and the second time t2. The second time t2 and the third time t3 bound a second time period 2. The maximum permissible contact separation between the contact pieces varies between the first separation s1 and the third separation s3 in the first time period. The maximum permissible contact separation between the contact pieces varies between the second separation s2 and the third separation s3 in the second time period. The arc which is burning between the contact pieces is finally quenched at the third time t3. Within the minimum and maximum separations between the contact pieces that are permissible within the two time periods 1, 2, the distance between the contact pieces can be changed in any desired way.

In FIG. 3, the movement sequence from FIG. 1 (represented by a solid line in the coordinate system) and the maximum permissible contact separations from FIG. 2 are superimposed. Within the two time periods 1, 2, the distance between the contact pieces always varies between the permissible limit values. In order to quench the arc as quickly as possible during a disconnection process, the movement sequence represented by the solid line shows the start of the first time period 1 and the time at which the first contact piece separation s1 is reached occurring at the same time.

Before the third separation s3 is reached, the separation speed of the contact pieces is reduced such that the distance between the contact pieces is within the permissible limit values at all times within the second time period 2. This ensures that the electric field caused by the current to be interrupted is always sufficiently large to support the rotation of the arc and to promote diffuse burning. Once the third time t3 has been reached, the separation of the contact pieces is continued until their limit positions are reached. By way of example, the dashed line shows a further movement sequence. In addition, further movement forms are also possible. However, these movement forms must ensure that the contact separations in the first time period 1 and in the second time period 2 vary within the permissible limits.

Braking devices illustrated in FIGS. 4 to 6 are used for braking a disconnection movement of the second contact piece 5. The braking devices are driven by means of a control system 13. Alternatively or in combination with the braking devices, it is also possible to provide for the drive device 14 to be controlled by the control system 13, in order to achieve the desired movement sequence for contact separation.

FIG. 4 shows a vacuum interrupter 3 in a vacuum switch having the contact pieces 4, 5 which form a contact system, in its disconnected position. The first contact piece 4 is mounted in a fixed position, while the second contact piece 5 can be driven by means of an operating rod 6. A ferromagnetic core 7 is arranged at the coupling point between the operating rod 6 and the second contact piece 5. This ferromagnetic core 7 is surrounded by a coil 8. The current flowing through the contact pieces 4, 5 flows through this coil 8. The combination of the coil 8 and the ferromagnetic core 7 represents an electromagnetic brake. During a disconnection process, the ferromagnetic core 7 moves through the coil 8, and the forces which occur during this process between the coil 8 and the ferromagnetic core 7 are in this case directed such that they counteract the disconnection movement, thus braking said disconnection movement. This force effect is not reduced until the disconnection arc has finally been quenched and, associated with this, the electric current has finally been interrupted, and the operating rod moves the second contact piece 5, which is attached to it, further without being influenced. The electromagnetic braking device, as well as the braking devices illustrated in FIGS. 5 and 6, are arranged on the vacuum switches such that the described movement sequences and limit ranges are satisfied. It has been found to be advantageous to allow the braking effect to start once the second separation s2 has been reached.

FIG. 5 shows a further embodiment of a vacuum switch, in its disconnected position, with an electromechanical brake. The operating rod 6 and the second switching contact piece 5 are concentrically surrounded by contact fingers 9 which are clamped in at one end. The contact fingers 9 have an additional brake lining 10, which increases the friction, on their inner faces. When an electric current flows via the contact fingers 9, the electromagnetic forces which then act press the contact fingers 9 together with the brake linings 10 against the operating rod 6 and against the movable contact piece 5. When the contact pieces 4, 5 are separated, then the brake linings 10 brake this movement immediately. Pressure from the contact fingers 9 decreases only after the final quenching of the arc and, associated with this, the interruption of the electric current, owing to the lack of electromagnetic forces, and the contact separation of the contact pieces 4, 5 can be carried out virtually without any influence from the electromechanical braking device.

FIG. 6 shows a further exemplary embodiment of a vacuum switch, in its disconnected position. Attachment parts 11 are mounted on the second contact piece 5 and are moved within a magneto-rheological liquid 12 during a movement of the second contact piece 5. The magneto-rheological liquid is arranged around the second contact piece 5 such that it is subjected to the electromagnetic field of the current flowing through the contact pieces 4, 5. This electromagnetic field increases the viscosity of the magneto-rheological liquid 12 and counteracts the movement of the second contact piece 5, with a braking effect, during a disconnection process. The intensity of the braking effect can be adapted by the configuration of the attachment parts 11 which are connected to the second contact piece 5. In addition to this variation capability, it is also possible to influence the viscosity of the magneto-rheological liquid 12 by applying an external electric field.

1. A control system for controlling a vacuum switch whose contact system has at least two contact pieces (4, 5) which can move relative to one another and are separated from one another at a changing speed during a disconnection process, and between which an arc which is to be quenched burns during the disconnection process, characterized in that the control system results in a given separation (s3) between the contact pieces being exceeded only after a time period (t3-t1) which is predetermined by the control system has elapsed.

2. A method for switching a vacuum switch whose contact system has at least two contact pieces (4, 5) which can move relative to one another and are separated from one another at a changing speed during a disconnection process, and between which an arc which is to be quenched burns during the disconnection process, characterized in that, until the arc is finally quenched, the average speed of the contact separation in a first phase is greater than the average speed of the contact separation in a second phase, which immediately follows the first phase.

3. A method for switching a vacuum switch whose contact system has at least two contact pieces (4, 5) which can move relative to one another and are separated from one another at a changing speed during a disconnection process, and between which an arc which is to be quenched burns during the disconnection process, characterized in that, in a first time period (1) but before the arc is finally quenched, the distance between the contact pieces (4, 5) is increased from a first contact separation (s1) which can be predetermined, at least to a second contact separation (s2), which can be predetermined, and at most to a third contact separation (s3), which can be predetermined, and in a second time period (2) which follows the first time period (1) in time and before the arc is finally quenched, the distance between the contact pieces (4, 5) remains between the second contact separation (s2) and the third contact separation (s3).

4. A method for switching a vacuum switch as claimed in claim 3, characterized in that the first time period (1) starts as soon as the first contact separation (s1) is reached.

5. The method for switching a vacuum switch as claimed in one of claims 3 or 4, characterized in that the end of the second time period (2) differs from the time at which the contact pieces (4, 5) reach the disconnected limit positions.

6. The method for switching a vacuum switch as claimed in one of claims 1 to 5, characterized in that the speed of contact separation is controlled as a function of the current to be disconnected.

7. A vacuum switch for carrying out the method as claimed in one of claims 2 to 6 and for operation by means of a control system as claimed in claim 1, characterized in that a movable contact piece has an associated electromagnetic braking device.

8. A vacuum switch for carrying out the method as claimed in one of claims 2 to 6 and for operation by means of a control system as claimed in claim 1, characterized in that a movable contact piece has an associated electromechanical braking device.

9. A vacuum switch for carrying out the method as claimed in one of claims 2 to 6 and for operation by means of a control system as claimed in claim 1, characterized in that parts (11) which are connected to a movable contact piece can move in a magneto-rheological liquid (12).
